(19) United States
(12) Patent Application Publication
(10) Pub. No.: US 2005/0231024 A1
(43) Pub. Date: Oct. 20, 2005

(54) Wheel rim cover

(76) Inventor: Chu-Li Wang, Tainan (TW)

Correspondence Address: BACON & THOMAS, PLLC, 625 SLATERS LANE, FOURTH FLOOR, ALEXANDRIA, VA, 22314, US

(21) Appl. No.: 10/929,496

(22) Filed: Aug. 31, 2004

(30) Foreign Application Priority Data
Apr. 14, 2004 (TW) 093205693

(51) Int. Cl. B60B 7/00

(52) U.S. Cl. 301/37.105

(57) ABSTRACT

A wheel rim cover includes a cover body and an outer cover. The cover body has a center base portion, an outer annular portion and a plurality of decorative members spaced apart between the center base portion and the outer annular portion and connected them together. The outer cover has a center plate portion and a plurality of decorative members extending radially from the center plate portion. Then the outer cover is combined with the cover body, with the decorative members of the outer cover fitting in hollows between every two decorative members of the cover body. A post-like projection is covered with a fastening member after passing through each projection hole of the outer cover, keeping stably the outer cover with the cover body. Then various cover bodies can be combined with various outer covers.

### BACKGROUND OF THE INVENTION

1. Field of the Invention

This invention relates to a wheel rim cover, particularly to one having its outer surface formed with an intriguing pattern to look sort of an unconventional appearance, also reducing its producing cost and speeding its assembling process.

2. Description of the Prior Art

Conventional wheel rim covers generally have a cover body and a ring combined together, and the cover body is integrally formed in a mold and provided with a plurality of engage blocks formed spaced apart equidistantly on an inner surface for engaging with the steel ring. As the cover body is formed to have a constant shape without necessity or possibility to be changed, the wheel rim cover has an objective for beautifying the outer appearance of a wheel of a vehicle and the view of a running wheel. Therefore, the outer appearance of a wheel rim cover is a key point for a consumer to select a wheel rim cover, and patent applications for wheel rim covers disclosed in the patent publication have been mostly in the scope of new designs. So it is no wonder that vehicle parts makers cudgel their brains in designing wheel rim covers provided with various decorative patterns to attract attentions of consumers and to meet the demand of the market trends. Designing and developing a new wheel rim cover involves a set of new molds, which may cost a big investment to makers.

### SUMMARY OF THE INVENTION

This invention has been devised to offer a wheel rim cover with rather complicated patterns on its outer surface, but its cost for molds can be reduced by using as less as possible for its molds needed, and its assembly can also be speeded up.

The feature of the invention a cover body provided with a center base portion and an outer annular portion connected with a plurality of decorative members spaced apart equidistantly to define a hollow between every two neighboring decorative members. Another feature of the invention is an outer cover to be combined on an outer surface of the cover body, and the outer cover has a center plate portion and a plurality of decorative members radially extending out from the center plate portion and spaced apart equidistantly to fit respectively in the hollows of the cover body. Then a same or various different cover bodies can be combined with a same or various different outer covers to form many different wheel rim covers with substantial less cost, by means of fastening members respectively covering tightly on post-like projections formed on the cover body and protruding projection holes of the outer cover.

### BRIEF DESCRIPTION OF DRAWINGS

This invention will be better understood by referring to the accompanying drawings, wherein:

FIG. 1 is an exploded perspective view of a wheel rim cover in the present invention;

FIG. 2 is a partial magnified cross-sectional view of the wheel rim cover in the present invention;

FIG. 3 is another partial magnified cross-sectional view of the wheel rim over in the present invention;

FIG. 4 is a cross-sectional view of the wheel rim cover in the present invention;

FIG. 5 is another cross-sectional view of the wheel rim cover in the present invention; and,

FIG. 6 is a perspective view of the wheel rim cover in the present invention.

### DETAILED DESCRIPTION OF THE PREFERRED EMBODIMENT

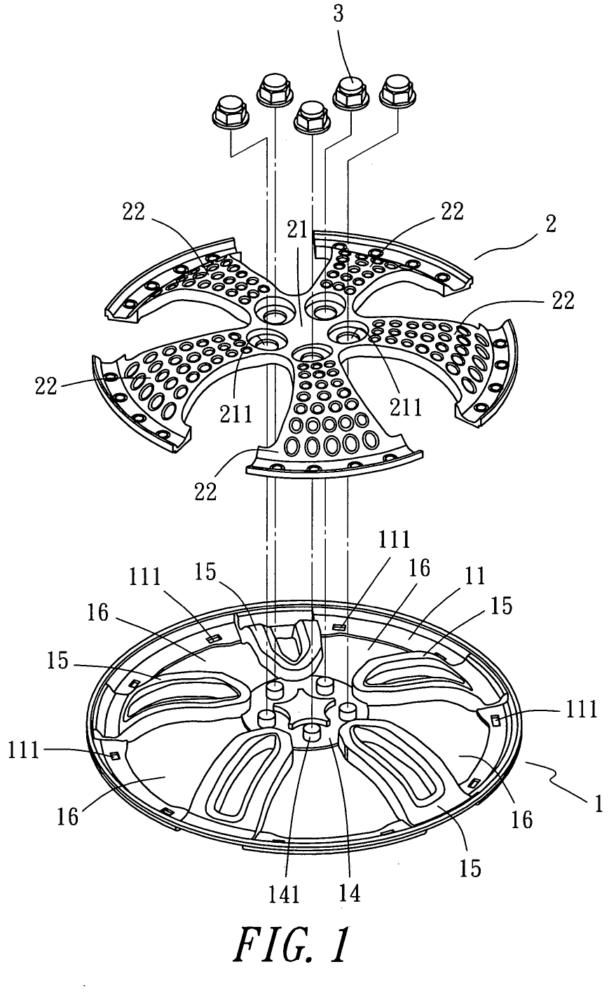

A preferred embodiment of a wheel rim cover in the present invention, as shown in FIGS. 1, 2 and 3, includes a cover body 1, an outer cover 2, and a plurality of fastening members 3 as main components.

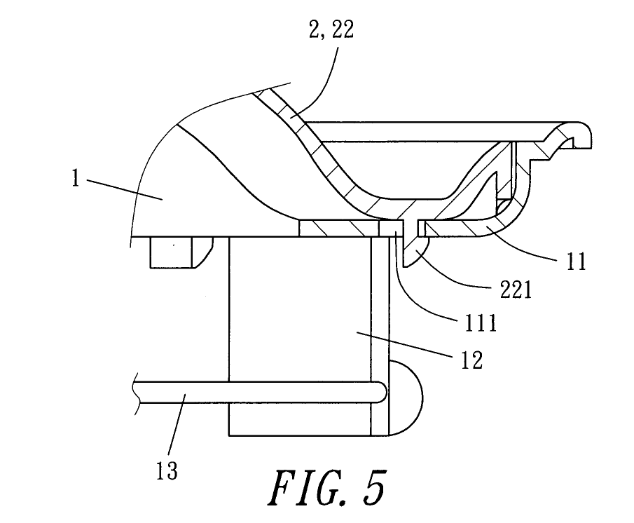

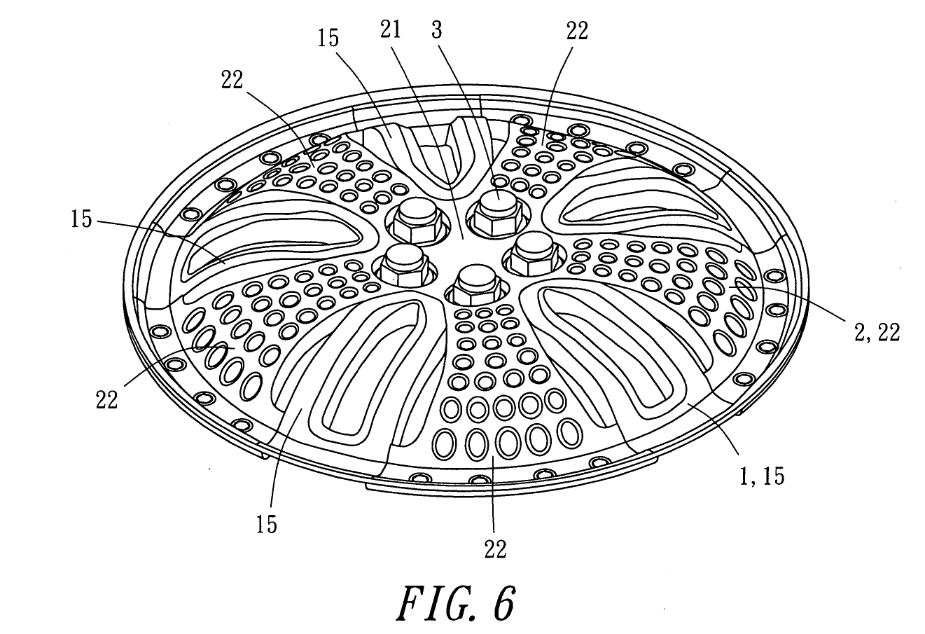

The cover body 1 is provided with an outer annular portion 2, a plurality of engage blocks 12 formed spaced apart equidistantly on an inner surface of the annular portion 2 and engage tightly with an inner surface of a wheel rim, and a steel ring 13 clamped by all the engage blocks 12 in place, as shown in FIG. 5 so as to maintain the supporting force of the engage blocks 12. The cover body 1 further has a center base portion 14 a little recessed and provided with a plurality of post-like projections 141 spaced around near its outer circumference. Further, a plurality of decorative members 15 are formed spaced apart equidistantly between the center base portion 14 and the outer annular portion 11, and a hollow 16 defined by two neighboring decorative members 15. The outer annular portion 111 further a plurality of insert holes 111 spaced apart properly.

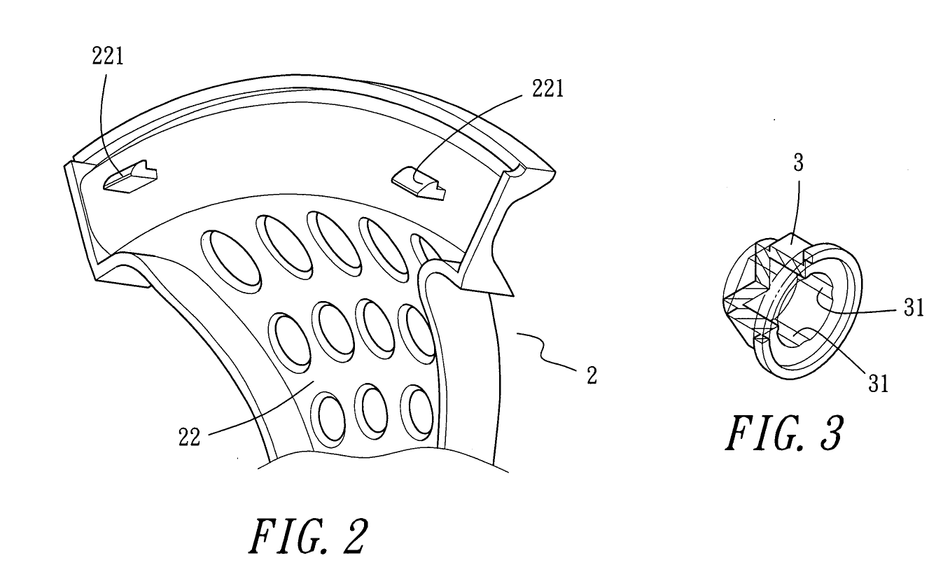

The outer cover 2 is to be covered on an outer surface of the cover body 1, provided with a center plate portion 21, a plurality of projection holes 211 bored in the center plate portion 21 for the post-like projections 141 to fit therein, and a plurality of decorative wing-like members 22 (for decoration) respectively fitting in the hollows 16 of the cover body 1, a plurality of engage studs 221 of an arrow-shape or the like formed on an inner surface of each wing-like member 22 as shown in FIG. 2 to insert in the insert holes 111 of the cover body 1 to combine stably the outer cover 2 with the cover body 1.

The fastening members 3 are of a recessed cap shape, covering respectively on the post-like projections 141, having a plurality of tapered projecting ribs 31 in an inner surface, as shown in FIG. 3, tensely pushing against the outer surface of the post-like projections 141 so as to keep stably the outer cover 2 on the outer surface of the cover body 1.

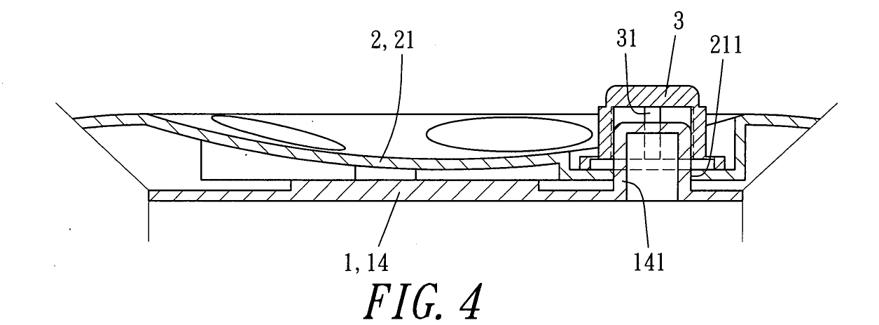

In assembling, referring to FIGS. 4 and 5, firstly, the outer cover 2 is placed on the outer surface of the cover body 1, with the post-like projections 141 respectively and protruding the projection holes 211 of the outer cover 2, and with the engage studs 221 of the wing-like members 22 respectively inserting tightly in the insert holes 111 of the outer annular portion 11 of the cover body 1 as shown in FIG. 4, finishing a first step of assembly.

Then the fastening members 3 are made to cover respectively the post-like projections 141 protruding the projection holes 211, and then forced to let the projecting ribs 31 tensely pushing against the outer surface of each post-like projection 141 as shown in FIG. 5. Thus, the fastening members 3 are not only tightly combined with the post-like projections 141, but also prevent the outer cover 2 from falling off, completely finishing assembly of the wheel rim cover in the invention.

However, it is not so important that the cover body 1 should necessarily be provided with the hollows 16 for receiving the wing-like members 22 of the outer cover 2 so as to form the outer cover 2 being on the same level as the cover body 1. The cover body 1 and the outer cover 2 can be designed to have different levels from each other to form two different levels—one high and another low—after combined together, with the post-like projections 141 still protruding the projection holes 211 and further fitting tightly in the fastening members 3, and with the engage studs 221 inserting in the insert holes 111. Therefore, different cover bodies 1 can combine with different outer covers 2 for forming two layered wheel rim cover, and reducing expenditure needed for molds as less as possible.

In general, makers can combine a same cover body with various differently patterned outer covers, or various differently patterned cover bodies with a same outer cover, or various differently patterned cover bodies with various differently patterned outer covers for forming many different wheel rim covers with considerable low cost.

While the preferred embodiment of the invention has been described above, it will be recognized and understood that various modifications may be made therein and the appended claims are intended to cover all such modifications that may fall within the spirit and scope of the invention.

1. A wheel rim cover comprising a cover body and an outer cover combined on an outer surface of said cover body:
Said cover body having an outer annular portion, a plurality of engage blocks formed spaced apart on an inner surface of said outer annular portion, said engage blocks clamping a steel ring and engaging tightly on an inner surface of a wheel rim, said steel rim supplying force for maintaining said engage blocks, said cover body further provided with a center base portion of a disc shape, a plurality of post-like projections formed spaced apart equidistantly around near an outer circumference of said center base portion, a plurality of decorative members provided spaced apart equidistantly between said center base portion and said outer annular portion for connecting said center base portion with said outer annular portion;
Said outer cover consisting of a center plate portion of nearly a disc shape and a plurality of decorative wing-like members extending out radially from said center plate portion and spaced apart equidistantly, said center plate portion having a plurality of projection holes spaced apart equidistantly to be fitted in by said post-like projections of said cover body, each said decorative wing-like member having engage studs on an inner surface of its outer end to fit tightly in said insert holes of said cover: and,
A fastening member of a recessed cap shape covered tightly on each said post-like projection of said cover body after each said post-like projection passes through each said projection hole of said outer cover so as to keep stably said outer cover with said cover body.

2. The wheel rim cover as claimed in claim 1, wherein each said engage stud is shaped as an arrow-like tenon so as to tightly fit in each said insert hole of said cover body.

3. The wheel rim cover as claimed as claim 1, wherein each said fastening member is provided with a plurality of projecting ribs on an inner surface for tensely pushing against an outer surface of each said post-like projection of said cover body.

4. The wheel rim covers as claimed in claim 1, wherein said ribs on the inner surface of each said fastening member is a little tapered.
